(19) United States
(12) Patent Application Publication
(10) Pub. No.: US 2004/0052580 A1
(43) Pub. Date: Mar. 18, 2004

(54) Connection clip for boltless storage units and work benches with concealed holes angle post

(76) Inventors: Alan Douglas Lawson, Walnut, CA (US); Dan A. David, La Canada, CA (US)

Correspondence Address: Rapid Rack Industries, Inc., Attn: Alan Lawson, 14421 Bonelli Street, Industry, CA, 91746, US

(21) Appl. No.: 10/245,914

(22) Filed: Sep. 18, 2002

(51) Int. Cl. B25G 3/36

(52) U.S. Cl. 403/396

(57) ABSTRACT

The Connection Clip is a simple method to be used when side by side or back to back storage units or work benches provided with concealed angle posts are to be held together. The clip is designed in such a way that four indents snap into the correspondent angle posts keyholes with a spring action, keeping the units from moving away from each other. The four point connection is quick and strong. The clip is concealed behind the exposed legs of the angle posts, therefore the connection is not obtrusive.

### CROSS-REFERENCE TO RELATED APPLICATIONS

Not Applicable

### STATEMENT REGARDING FEDERALLY SPONSORED RESEARCH AND DEVELOPMENT

Not Applicable

### REFERENCE TO SEQUENCE LISTING, A TABLE OR A COMPUTER PROGRAM LISTING COMPACT DISK APPENDIX

Not Applicable

### BACKGROUND OF THE INVENTION

Boltless storage units and work benches are usually composed of angle posts, beams and shelves. Other accessories like hang bars, dividers, supports, drawers etc. can be used. Storage units can be single or multiple.

The beams are connected to posts with rivets. The angle posts have keyhole shaped punched holes. Angle posts with concealed holes are folded in such a way that the leg of the angle is doubled and the holes are punched in the interior fold so they are hidden behind the exterior fold (Drawing 2). Special rivets are permanently connected to the beams. They go into the larger side of the keyholes and then the beam is tapped down with a mallet so the rivets move into the smaller hole. Gravity and the load hold the beams into place.

Freestanding units are usually composed of four posts and the necessary number of beams and other components. Multiple freestanding units can be installed side by side or back to back (Drawing 3).

### BRIEF SUMMARY OF THE INVENTION

The purpose of the Connection Clip is to attach two side by side or back to back shelving units or work benches units together by connecting the adjacent angle posts with a spring action connection.

### BRIEF DESCRIPTION OF DRAWINGS

Drawing 1—General isometric view

Drawing 2—Concealed Angle Post

FIG. 1—Front view

FIG. 2—Back view

Drawing 3—Multiple freestanding shelving units example

Drawing 4—Concealed Angle Post Connection

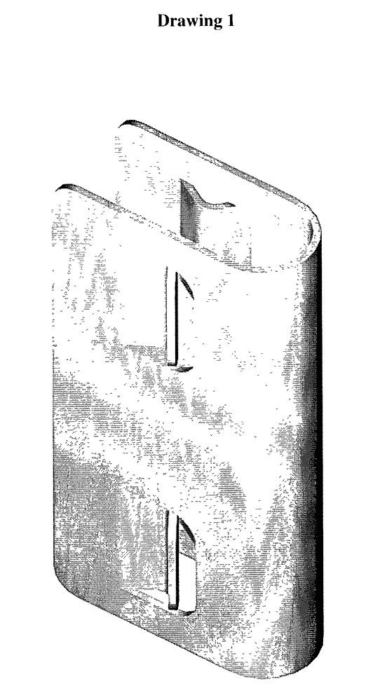

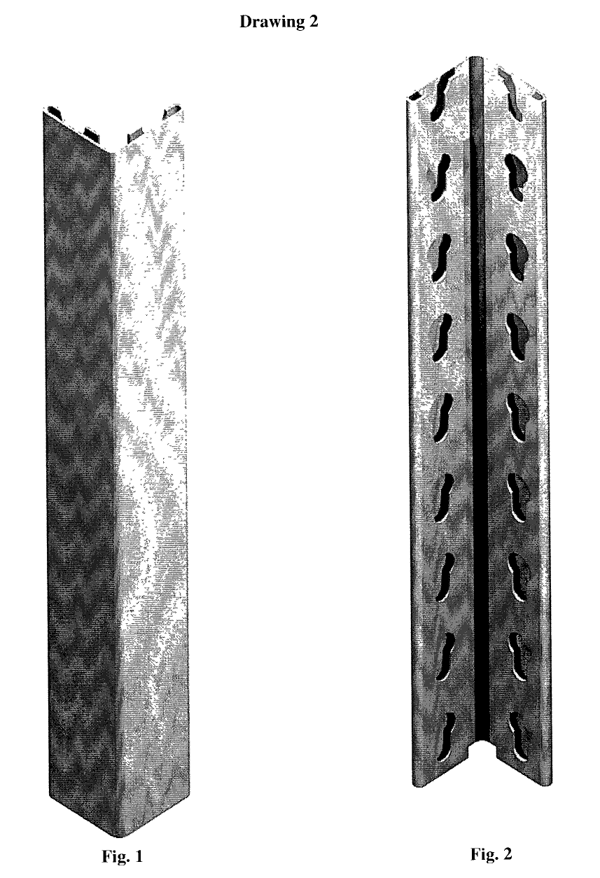

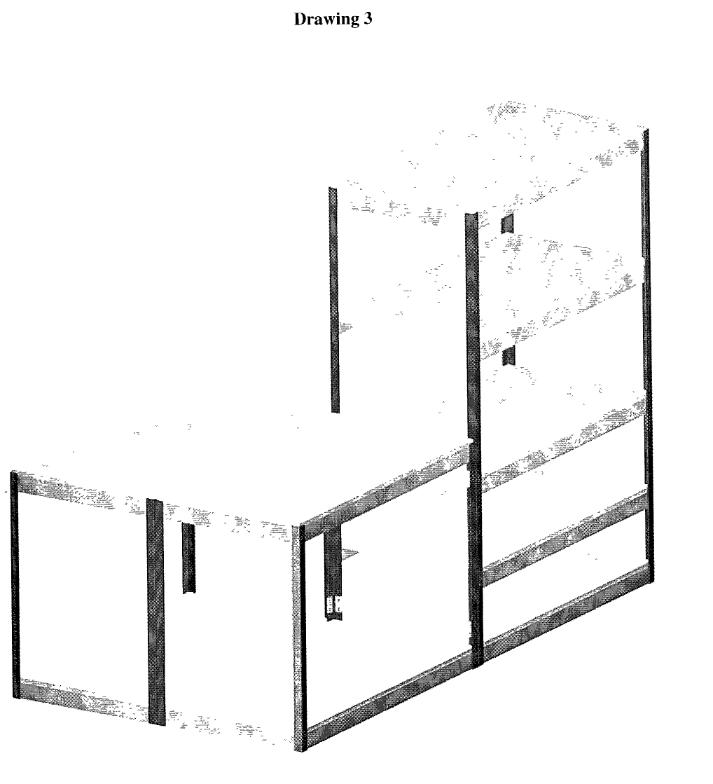

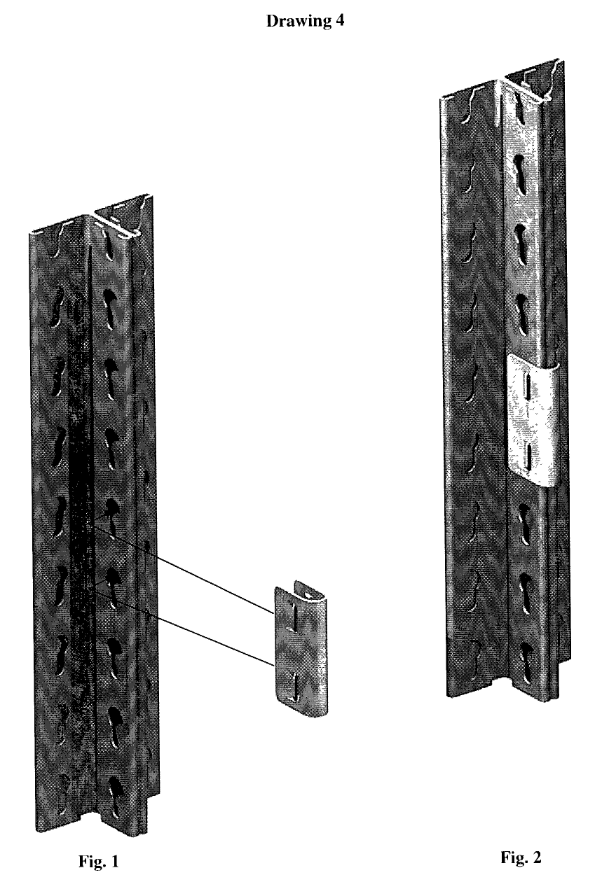

FIG. 1—Clip positioning

FIG. 2—Connected posts

### DETAILED DESCRIPTION OF THE INVENTION

The Connection Clip is a folded piece of spring steel (Drawing 1).

The clip is folded in such a way that two adjacent legs of the angle posts fit inside it when held together.

Four indents are provided, two on each side of the clip. They are positioned and sized to match the angle posts keyholes.

The clip is positioned at the keyhole level and then pressed against the two adjacent legs of the angle posts (Drawing 4—FIG. 1).

When pressed against the posts, the indents snap into the keyholes and the clip keeps the posts tight together with a four point connection (Drawing 4—FIG. 2).

Based on the size of the units and the desired rigidity of the assembly, one or more clips can be used per pair of posts.

1. What I claim as my invention is a method of connecting side by side or back to back boltless storage units and work benches using a spring clip connection that holds together the adjacent concealed angle posts.
